(19) United States
(12) Patent Application Publication
(10) Pub. No.: US 2011/0176437 A1
(43) Pub. Date: Jul. 21, 2011

(54) TRAFFIC VOLUME MONITORING SYSTEM

(75) Inventor: Minoru SEKIGUCHI, Yokohama (JP)

(73) Assignee: Hitachi, Ltd.

(21) Appl. No.: 12/853,151

(22) Filed: Aug. 9, 2010

(30) Foreign Application Priority Data
Jan. 20, 2010 (JP) 2010-009633

(51) Int. Cl. H04L 12/26

(52) U.S. Cl. 370/252

(57) ABSTRACT

A traffic monitoring system includes a communication apparatus for communicating with each terminal apparatus via a plurality of communication lines; and a monitor apparatus for monitoring a traffic of each terminal apparatus, wherein the communication apparatus establishes sessions with the terminal apparatuses by logical lines for each communication line; and the monitor apparatus monitors a traffic of each terminal apparatus for each flow type in each logical line.

### INCORPORATION BY REFERENCE

The present application claims priority from Japanese application JP2010-009633 filed on Jan. 20, 2010, the content of which is hereby incorporated by reference into this application.

### BACKGROUND OF THE INVENTION

The present invention relates to a network system for providing services to service users via a network, and more particularly to a traffic monitoring system for monitoring a traffic volume of a particular flow by a service user and providing a different handling method to each abnormal flow.

On the one hand, the advancement of recent broadband technologies and the development of recent distribution technologies have made the Internet prevail rapidly, and on the other hand, damages caused by attacks threatening safety of the Internet are recognized as important social issues. Several countermeasures have been developed including an invasion detection system. However, in broadband connection services provided by a communication carrier, a conventional abnormal traffic detection method detects presently traffic abnormality at the timing when some abnormal state is recognized by sensing a concrete influence such as degraded performance of a protection target apparatus, inability of providing services, and lowered access performance caused by an excess traffic load. In this environment, abnormal traffic by some subscribers makes therefore other subscribers unable to receive services sufficiently.

A system has therefore been proposed in which when an abnormal state is detected while monitoring traffic flows of subscribers, use of the subscriber forming an abnormal traffic is restricted (e.g., US 2008/0089233A1, Shimojo et al.).

### SUMMARY OF THE INVENTION

This system detects an abnormal flow by using a transmission source IP address, a transmission destination IP address, and a transmission source port number or a transmission destination port number. The service type provided by a present communication carrier is complicated, and there is a wide variety of protocols to be processed by the communication carrier. A range of threats to be attacked by an abnormal packet is therefore expanding. The sufficient effects may not be exhibited by a conventional flow detection method using a transmission source IP address, a transmission destination IP address, and a transmission source port number or a transmission destination port number. One of important issues is to monitor a flow more finely in order to supply users with stable network resources.

An object of the present invention is to provide stable use of network resources by monitoring a flow more finely, and further to monitor a target network edge apparatus and monitor/detect/handle an abnormal state at an earlier stage at an edge of a broadband access network nearest to a subscriber.

In order to settle the above-described issues, the present invention provides a traffic monitoring system including: a communication apparatus for communicating with each of a plurality of terminal apparatuses via a plurality of communication lines; and a monitor apparatus for monitoring a traffic of each of the plurality of terminal apparatuses, wherein: the communication apparatus establishes sessions with the plurality of terminal apparatuses by logical lines for each of the plurality of communication lines; and the monitor apparatus monitors a traffic of each of the plurality of terminal apparatuses for each flow type in each of the plurality of logical lines.

According to the present invention, since an abnormal flow is monitored/detected/handled at an edge of a broadband access network nearest to a subscriber, it is possible to prevent at an earlier stage an inflow of an abnormal flow into the network. Further, it is possible to shorten a time from an occurrence of a problem by an abnormal flow to handling the problem. Furthermore, it is possible to set finely a type of a monitor target flow, and the effects are exhibited in detecting and handling an abnormal flow, particularly a control series packet having a relatively high process load on an apparatus. There is a merit of reducing an operation cost because a server manages collectively collection, monitor and handling of an abnormal flow.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates an example of a network system configuration diagram of present services.

FIG. 2 illustrates an example of a functional block diagram of a user authentication server.

FIG. 3 illustrates an example of a user session management table of the user authentication server.

FIG. 4 illustrates an example of an AVP format of an attribute #5 (NAS-Port) of the user authentication server.

FIG. 5 illustrates an example of a network system configuration diagram of a first embodiment of the present invention.

FIG. 6 illustrates an example of a functional block diagram of a user monitor server.

FIG. 7 illustrates an example of a monitor table of the user monitor server.

FIG. 8 illustrates an example of a user session management table of the user monitor server.

FIG. 9 illustrates an example of an excess traffic volume table of the user monitor server.

FIG. 10 illustrates an example of a monitor flow diagram in the user monitor server.

### DESCRIPTION OF THE EMBODIMENTS

An embodiment of the present invention will be described with reference to the accompanying drawings. The present invention is intended not to be limited to the following embodiment.

In this embodiment, for example, in Internet connection services and the like, when an apparatus in a user home such as PC is connected to a network, each flow type of an individual apparatus is monitored to perform flow control finely.

For example, in the Internet, when a user connects an apparatus in a user home such as PC to the Internet, the apparatus is first connected to a network access server (NAS) prepared by an Internet service provider (ISP), and then connected to the Internet via a network of ISP.

NAS has generally a plurality of physical ports, and each port is able to have a plurality of logical ports for covering a plurality of user home apparatuses. In this embodiment, each flow in a logical port to be processed by NAS is monitored to perform flow control finely for each user.

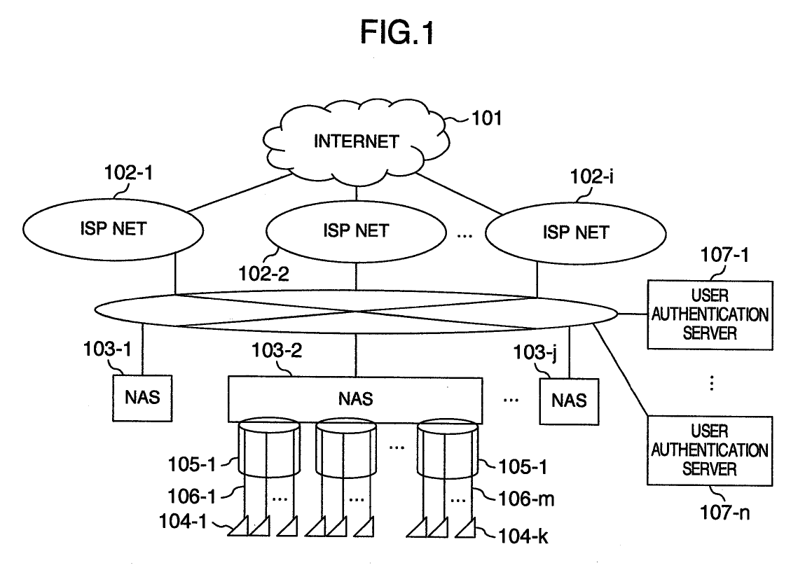

FIG. 1 illustrates an example of a network configuration for realizing Internet connection services. Reference numeral 101 represents the Internet, reference numeral 102 represents an Internet Service Provider (ISP) network, reference numeral 103 represents a network access server (NAS), and reference numeral 104 represents a user home apparatus. NAS 103 is an apparatus to be used for providing services of connecting a user home apparatus 104 to the Internet 101 via the ISP network 102, wherein each physical interface 105 has a plurality of logical interfaces 106, and the user home apparatus 104 is covered by a corresponding one of the logical interfaces 106. The physical interface 105 is an interface to be used for connection to a physical line, and the logical interface 106 is an interface to be used for connection to a logical line. Namely, NAS is connected to the user home apparatus 104 via a logical line in a physical line.

A line type of the physical interface 105 provided as an access line is not specified explicitly, and may be 802.11a, 100BASE-T or the like. NAS 103 together with a user authentication server 107 authenticates each user home apparatus 104. After the authentication is approved, a connection is established between NAS 103 and the user home apparatus 104, and data is transferred from the user home apparatus 104 to the ISP network 102 via NAS 103.

The user authentication server 107 has a database for managing a user accessed from a remote site. Upon reception of an authentication request from NAS 103, the user authentication server authenticates a user by confirming a user name and a password stored in the database. As the user authentication server 107 completes user authentication and connection is authorized, access permission is returned to NAS 103.

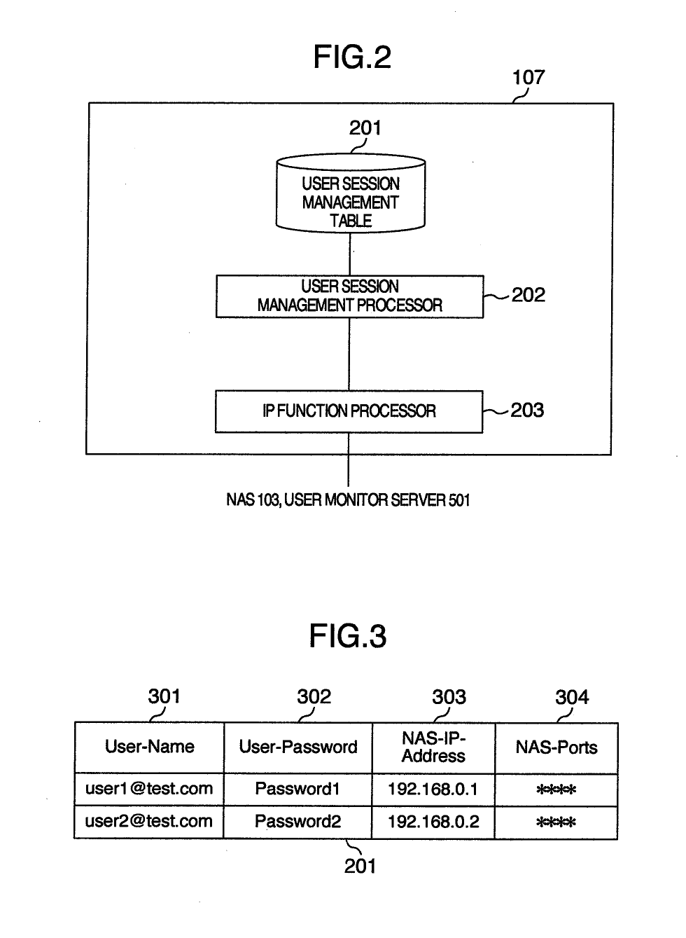

As illustrated in FIG. 2, the user authentication server 107 has an IP function processor 203 for communications, a user session management table 201, and a user session management processor 202 for registration and deletion of session information of each user relative to the user session management table 201. The contents of the user session management table 201 are illustrated in FIG. 3. Data regarding each user requested to be authenticated (accessed) by the IP function processor 203 is registered in each entry of the user session management table 201. The user session management processor 202 extracts an attribute #1 (User-Name 301), an attribute #2 (User-Password 302), an attribute #4 (NAS-IP-Address 303) and an attribute #5 (NAS-Port 304) of Attribute Value Pairs (AVP) to be used for authentication request (Access-Request), and the extracted data is stored in the user session management table 201.

The attribute #1 is AVP indicating the name of a user to be authenticated, the attribute #2 is AVP indicating the password of the user to be authenticated, the attribute #4 is AVP indicating an IP address for identifying NAS requesting user authentication, and the attribute #5 is AVP indicating a physical port number of NAS authenticating the user.

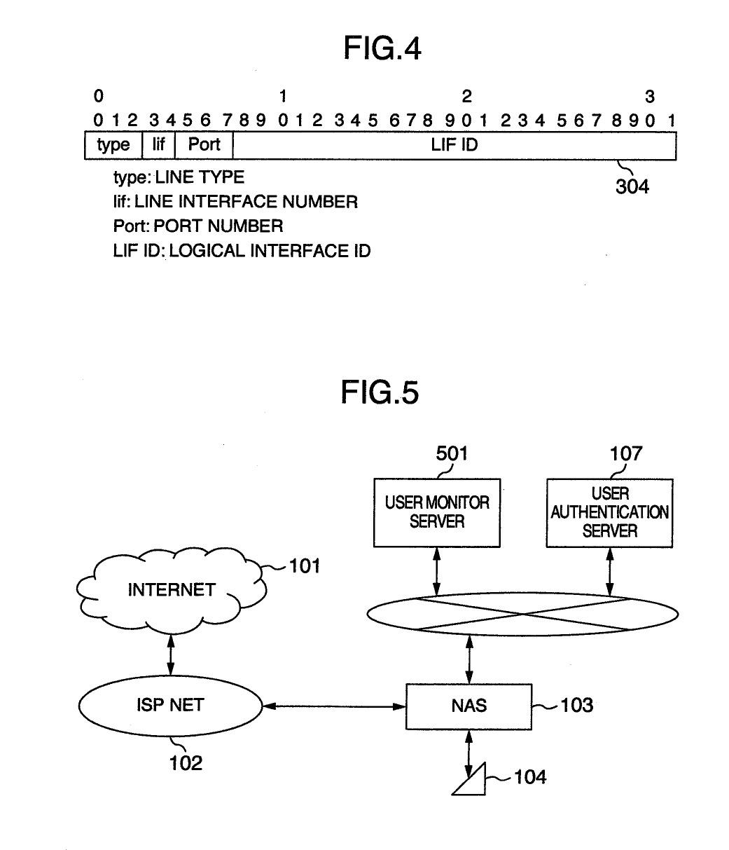

FIG. 4 illustrates an example of an AVP format of the attribute #5 (NAS-Port 304). Registration of the session information of each user into the user session management table 201 is executed when an Accounting-Request (Acct-Status-Type=1) for the user is received from NAS 103. Deletion of the registered session information of each user from the user session management table 201 is executed when an Accounting-Request (Acct-Status-Type=2) for the user is received from NAS 103.

The user authentication server 107 has a function of providing each registered user with the user information stored in the user session management table 201, upon request from an external.

FIG. 5 is a diagram illustrating the configuration of a network system according to the embodiment of the present invention. This network system is constituted of a user monitor server 501, a network access server (NAS) 103, a user authentication server 107, the Internet 101, an Internet service provider (ISP) network 102 and a user home apparatus 104. For the simplicity of description, it is assumed hereinafter that a session has already been established between the user home apparatus 104 and NAS 103, and that this state has already been registered in the user session management table 201 of the user authentication server 107.

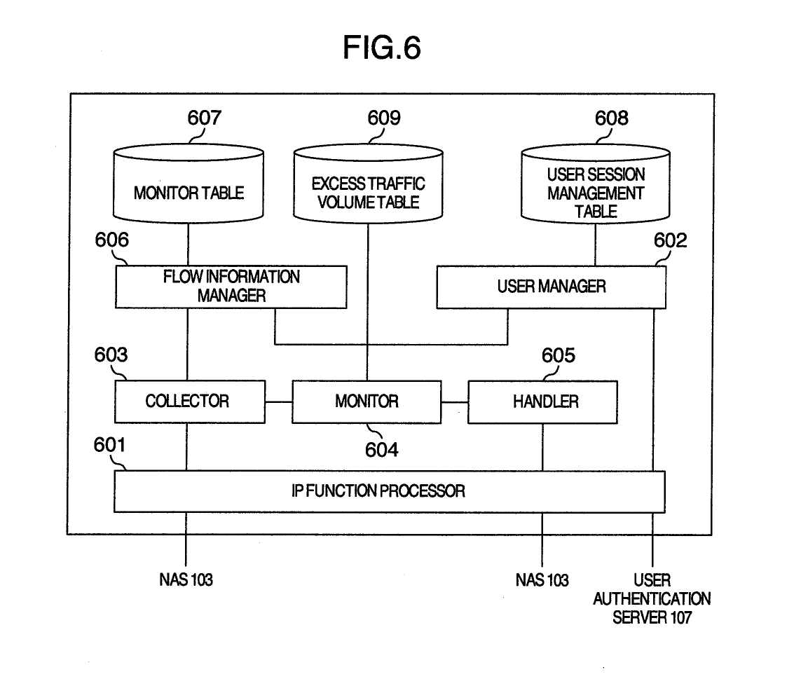

FIG. 6 is a functional block diagram of the user monitor server 501. As illustrated in FIG. 6, the user monitor server 501 has an IP function processor 601, a user manager 602, a collector 603, a monitor 604, a handler 605, a flow information manager 606, a user monitor table 607, a user session management table 608, and an excess traffic volume table 609.

The IP function processor 601 has an IP packet processing function for communications between NAS 103 and the user authentication server 107. The user manager 602 periodically acquires information stored in the user session management table 608 from the user authentication server 107 to manage and update a user connection state. The collector 603 collects information on a transmission/reception traffic volume per hour flowing through each user session in NAS 103-1 to NAS 103-j. A Simple Network Management Protocol (SNMP) may be used for collection.

The collector 603 refers to the user session management table 608 to distinguish a user session to be collected. A user session to be collected by the collector 603 is a user session registered in the user session management table 608. Information on the transmission/reception traffic volume is collected by the collector 603 for each flow type registered in the user monitor table 607. Information on the traffic volume collected by the collector 603 is sent to the monitor 604.

The monitor 604 cross-checks the information on the traffic volume collected by the collector 603 and information stored in the user monitor table 607. If there is an excess traffic, a record is added to the excess traffic volume table 609, and it is confirmed whether the record exists in the excess traffic volume table 609 (whether the excess traffic exists) to judge how the session is handled. How the session is handled may be judged directly through cross-check between the information on the traffic volume collected by the collector 603 and information stored in the user monitor table 607. If it is judged that handling is required, the monitor 604 sends a handling execution instruction to the handler 605. Upon reception of the execution instruction from the monitor 604, the handler 605 handles the target user session. For example, by using SNMP, the handler 605 makes, via NAS 103, the user session transmits a handling instruction to the logical interface 106. A transmission method may use a Command Line Interface (CLI).

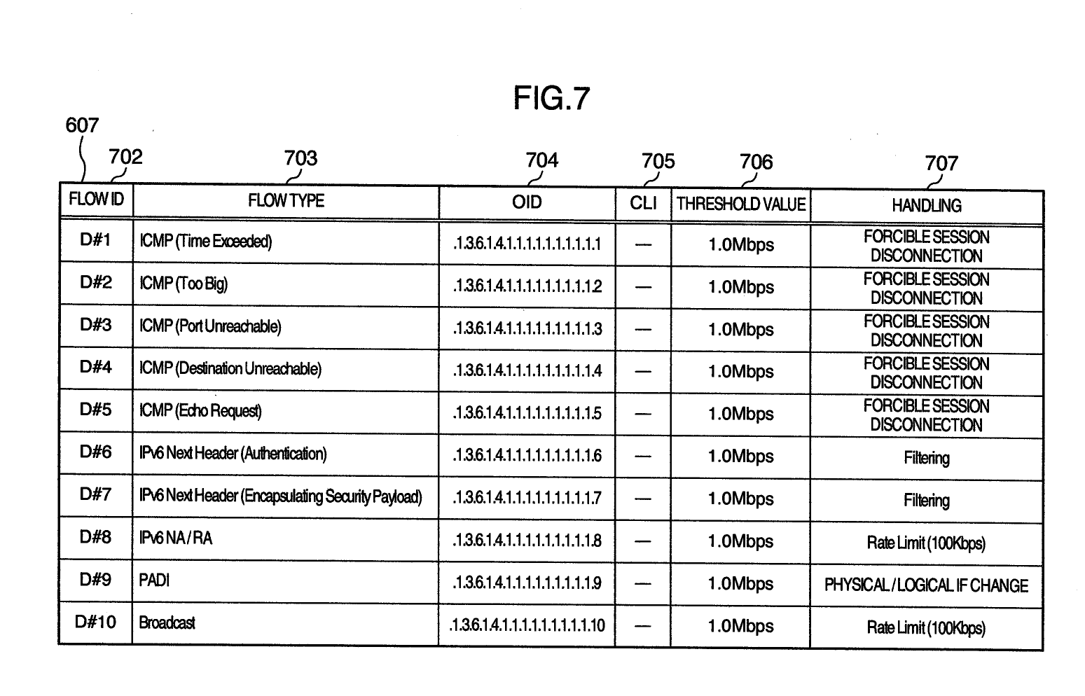

FIG. 7 illustrates an example of a format of the monitor table 607. The monitor table 607 includes a flow type 703 indicating the flow contents or a packet type to be monitored in a flow, an Object Identifier (OID) 704 and a CLI 705 to be transmitted when a traffic volume of NAS 103 is collected, a threshold value 706 to be used as a judgment criterion for judgment of an abnormal flow, and a handling method 707 to be used when the flow is judged abnormal, respectively for each flow ID 702. When the monitoring target specified in flow type 703 is detected in a flow and the traffic volume of the flow exceeds the threshold specified in threshold value 706, the flow is judged as abnormal and the abnormal flow is handled according to handling method 707. An operation manager is able to perform registration and update of the monitor table 701 freely after the manger logs in the user monitor server 501.

The flow type 703 may consist of a protocol name and a message content and. For example, the protocol name is ICMP (Internet Control Message Protocol) and a message content includes “Time Exceeded” which indicates that the packet does not reach the destination in a predetermined time, “Too Big” which indicates the data is too big, “Port Unreachable” which indicates that the packet does not reach the designated port, “Destination Unreachable” which indicates that the packet does not reach the destination, and “Echo Request” which requires the echo. The flow type may be a specific field of a packet and its content. The specific field is IPv6 Next header and the content includes “Authentication” which is used for the authentication, and “Encapsulating Security Payload (ESP)” which is used for the data encryption. The flow type may be a specific packet, such as an “IPv6 NA (Neighbor Advertisement)/RA (Router advertisement)” packet for address resolution or a broadcast packet for broadcasting data. The flow type may be a specific protocol, such as “PADI (PPPoE Active Discovery Initiation)”.

The handling method 707 includes “forcible session disconnection” for forcibly disconnecting the session of the monitored flow, “filtering” for filtering the monitored flow under a predetermined condition, “Rate Limit” for limiting the bandwidth of the monitored flow, and “Physical/Logical IF change” for changing the physical or logical interface for transferring the monitored flow. For example, when handling method 707 is “filtering”, the abnormal flow is filtered not to enter the network. When handling method 707 is “physical/logical IF change”, the physical/logical interface of NAS side that the abnormal flow uses is changed.

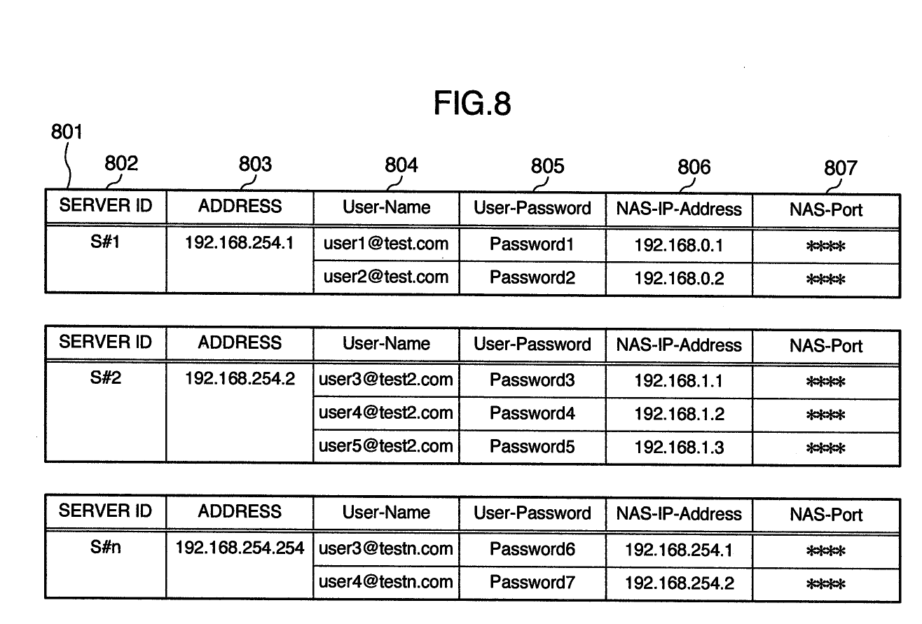

FIG. 8 illustrates an example of a format of the user session management table 801. Both the user session management tables 201 and 608 illustrated in FIGS. 2 and 6, respectively, have the same format. The format will be described by using the user session management table 801. The user session management table 801 includes an authentication server ID 802 for identifying the user authentication server 107, a server address 803 indicating the IP address of the user authentication server 107, a User Name 804 to be used for identifying a user, a User-Password 805 to be used when a user issues an authentication request, a NAS-IP-Address 806 indicating an IP address of NAS 103, and a NAS-Port indicating a position where a user session exists on NAS 103.

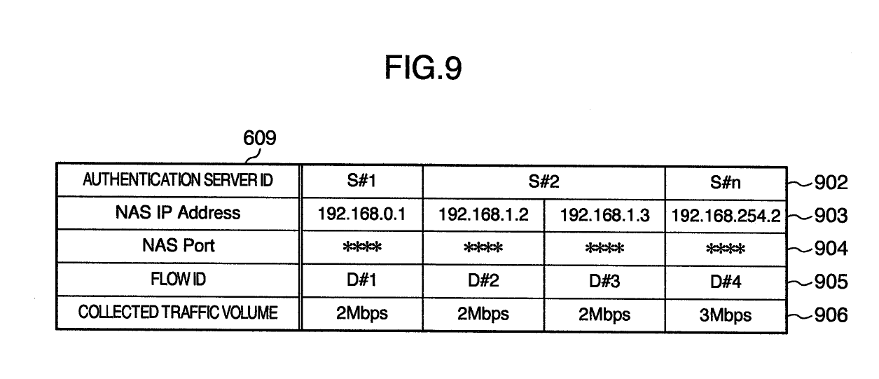

FIG. 9 illustrates an example of a format of the excess traffic volume table 609. The excess traffic volume table 609 includes an authentication server ID 902 for identifying the user authentication server, a NAS-IP-Address 903 indicating the IP address of NAS 103, a NAS-Port 904 indicating a position where a user session exists on NAS 103, a flow ID 905 for identifying the flow, and a collected traffic volume 906 indicating the collection results of the traffic volume. A plurality of flow IDs may exist for NAS-IP-Address 903 and NAS-Port 904. The excess traffic volume table 609 registers each flow whose traffic volume exceeds the threshold value, for each user authentication server 107. If the flow has a traffic volume smaller than the threshold value, the entry of this flow is deleted from the excess traffic volume table 609.

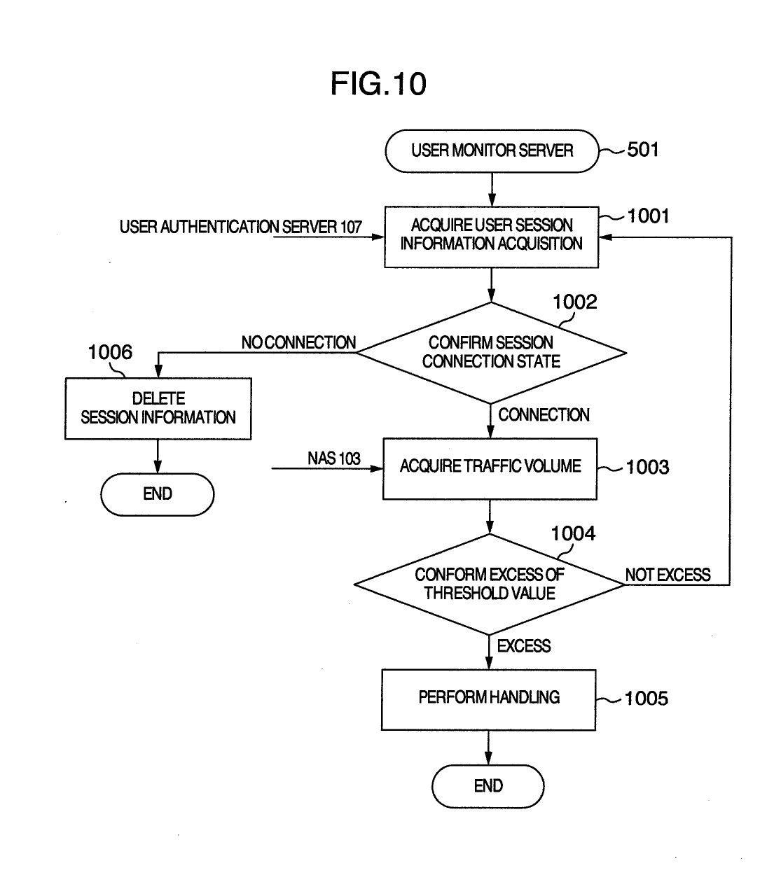

FIG. 10 is a flow chart illustrating handling an arbitrary user session already connected to the user monitor server. Step 1001 is a user session information acquiring process. Step 1002 is a process of confirming a session connection state, Step 1003 is a process of acquiring a transmission/reception traffic volume, Step 1004 is a process of confirming whether a traffic volume is in excess of the threshold value, Step 1005 is a handling execution process, and Step 1006 is a session information deletion process.

More specifically, in the user session information acquisition process, the user manager of the user monitor server 501 acquires information stored in the user session management table 201 from the user authentication server 107 via the IP function processor 601, and copies the acquired information to the user session management table 608 (Step 1001).

Next, in the session state confirmation process, the monitor 604 refers to the information stored in the user session management table 608, and cross-checks the contents of the user session management table 608 before copying and the contents of the user session management table 608 after copying to thereby confirm whether there is a user session with completed user authentication and in a connection state (Step 1002).

If confirmation indicates that a user session in a connection state does not exist (a user session existing before copying and not existing after copying), then in the session information deletion process, the target user session information is deleted from the user session management table 801 (Step 1006). If there is a user session in the connection state, then in the transmission/reception traffic volume acquisition process, the monitor 604 acquires a traffic volume of each flow type of the target flow session registered in the monitor table 607, via the collector 603 and IP function processor 601 (Step 1003).

Next, in the process of confirming whether a traffic volume exceeds the threshold value, the acquired traffic volume information is compared with the threshold value (Step 1004).

If the comparison result indicates that the acquired traffic volume is smaller than the threshold value, then in the user session information acquisition process, information stored in the user session management table 201 is acquired from the user authentication server 107, and the information stored in the user session management table 801 is updated (Step 1001).

If the acquired traffic volume is larger than the threshold value, then in the handling execution process, the target user session is handled in accordance with the contents of the handling method 707 of the monitor table 701 (Step 1005). In accordance with information on the acquired traffic volume, the threshold value may be compared directly with the traffic volume, or the contents of the excess traffic volume table 609 in FIG. 9 may be updated, and in accordance with the updated contents, the process of judging whether the traffic volume exceeds the threshold value may be executed.

The processes at Steps 1002 to 1006 may be executed sequentially for each individual user session contained in the user session information acquired by the process at Step 1001, or each process may be executed for all user sessions at the same time.

The above-described operations allow an abnormal flow to be monitored/detected/handled at an edge of the broadband access network nearest to each subscriber, and further the high effects are exhibited in detecting and handling an abnormal flow of a control series packet.

The present invention allows an electronic communication service provider to use at a network edge, and a wholesale company to use at a network edge.

It should be further understood by those skilled in the art that although the foregoing description has been made on embodiments of the invention, the invention is not limited thereto and various changes and modifications may be made without departing from the spirit of the invention and the scope of the appended claims.

1. A traffic monitoring system comprising:
a communication apparatus for communicating with each of a plurality of terminal apparatuses via a plurality of communication lines; and
a monitor apparatus for monitoring a traffic of each of said plurality of terminal apparatuses, wherein:
said communication apparatus establishes sessions with said plurality of terminal apparatuses by logical lines for each of said plurality of communication lines; and
said monitor apparatus monitors a traffic of each of said plurality of terminal apparatuses for each flow type in each of said plurality of logical lines.

2. The traffic monitoring system according to claim 1, wherein said monitor apparatus transmits a predetermined handling instruction to said communication apparatus if a traffic of a flow of a monitor target exceeds a predetermined threshold value.

3. The traffic monitoring system according to claim 1, wherein said flow type contains an ICMP Time Exceeded message.

4. The traffic monitoring system according to claim 1, wherein said flow type contains an ICMP Too Big message.

5. The traffic monitoring system according to claim 1, wherein said flow type contains an ICMP Port Unreachable message.

6. The traffic monitoring system according to claim 1, wherein said flow type contains an ICMP Destination Unreachable message.

7. The traffic monitoring system according to claim 1, wherein said flow type contains an ICMP Echo Request message.

8. The traffic monitoring system according to claim 1, wherein said flow type contains an IPv6 packet containing an Authentication Header message.

9. The traffic monitoring system according to claim 1, wherein said flow type contains an IPv6 packet containing an Encapsulated Security Payload.

10. The traffic monitoring system according to claim 1, wherein said flow type contains an IPv6 packet containing a Neighbor Advertisement (NA) or Router Advertisement (RA).

11. The traffic monitoring system according to claim 1, wherein said flow type contains a PPPoE Active Discovery Initiation (PADI) packet. an IPv6 containing an Authentication Header message.

12. The traffic monitoring system according to claim 1, wherein said flow type contains a broadcast packet.

13. The traffic monitoring system according to claim 2, wherein said handling instruction contains a forcible disconnection process for a session of a flow of said monitor target.

14. The traffic monitoring system according to claim 2, wherein said handling instruction contains a filtering process for a session of a flow of said monitor target.

15. The traffic monitoring system according to claim 2, wherein said handling instruction contains a process of changing a physical or logical line for transferring a flow of said monitor target.

16. The traffic monitoring system according to claim 2, wherein said handling instruction contains a restriction of a transfer amount of a flow of said monitor target.

17. The traffic monitoring system according to claim 1, further comprising:
an authentication apparatus for executing an authentication process of each of said plurality of terminal apparatuses, together with said communication apparatus, wherein:
said monitor apparatus acquires session information from said authentication apparatus, and in accordance with said session information, monitors a traffic of each of said plurality of terminal apparatuses for each flow.

18. The traffic monitoring system according to claim 1, wherein said monitor apparatus collects a traffic of each of said plurality of terminal apparatuses covered by said communication apparatus, from said communication apparatus.

19. The traffic monitoring system according to claim 1, wherein SNAP is used for collecting a traffic.

20. The traffic monitoring system according to claim 1, wherein SNAP is used for transmitting said handling instruction.
